(19) United States
(12) Patent Application Publication
(10) Pub. No.: US 2023/0379238 A1
(43) Pub. Date: Nov. 23, 2023

(54) PATH COMPUTATION DEVICE, PATH COMPUTATION METHOD, AND PATH COMPUTATION PROGRAM

(71) Applicant: Nippon Telegraph and Telephone Corporation, Tokyo (JP)

(72) Inventors: Kazuto Toyozumi, Musashino-shi, Tokyo (JP); Ken TAKAHASHI, Musashino-shi, Tokyo (JP); Satoshi NAKATSUKASA, Musashino-shi, Tokyo (JP)

(21) Appl. No.: 18/024,656

(22) PCT Filed: Sep. 11, 2020
(86) PCT No.: PCT/JP2020/034394

§ 371 Date: Mar. 3, 2023

(51) Int. Cl. H04L 45/24; H04L 47/125; H04L 45/00

(52) U.S. Cl. CPC H04L 45/24; H04L 47/125; H04L 45/22

(57) ABSTRACT

A route calculation device (1) includes: an input unit (11) that receives input parameters including an index for selecting a path to be set in a communication system (20); a route calculation unit (12) that selects a reference path based on the index and preferentially selects, from among one or more other paths each of which passes through a route different from the reference path, a path having a lower degree of sharing a router through which the reference path passes; and a route setting unit (15) that sets the reference path and the another path selected by the route calculation unit (12) in the communication system (20).

### TECHNICAL FIELD

The present invention relates to a route calculation device, a route calculation method, and a route calculation program.

### BACKGROUND ART

A source routing method has been studied that explicitly designates, with transfer labels, relay devices through which data passes from a transmission source to a destination, which serve as a path (transfer route) of a network.

Non Patent Literature 1 proposes segment routing (SR) as a representative technique of the source routing method. In SR, a transfer label list called a segment ID (SID) list is generated as a path, and transfer is performed according to the path.

A path that relays data from the same transmission source to the same destination may have an intermediate route branched, and various possible paths are generated. Therefore, the following information is exemplified as traffic engineering (TE) indices for determining a path to be adopted from the possible paths.
Topology information by an interior gateway protocol (IGP)
Route information by the Border Gateway Protocol (BGP)
TE link information
Extended TE link information (delay information and loss information)

Using a measured value as delay information by the Two-Way Active Measurement Protocol (TWAMP) or the like makes it possible to select a path with a minimum delay to the destination.

### CITATION LIST

### Non Patent Literature

Non Patent Literature 1: IETF RFC8402, “Segment Routing Architecture”, [online], July 2018, [Searched on Sep. 2, 2020], Internet
   <URL:https://tools.ietf.org/html/rfc8402>

### SUMMARY OF INVENTION

### Technical Problem

In routing in SR, using a plurality of paths in a load-balanced manner makes it possible to distribute traffic in a plurality of directions. The plurality of paths are paths that relay data from the same transmission source to the same destination, but intermediate routes are different from each other.

FIG. 8 is an explanatory diagram illustrating an example of transfer by SR.

In a network topology diagram indicated by a reference sign 801, data is transferred from a host H1 to a host H2 accommodated in an edge node PE2 via an edge node PE1 and routers R1 to R6. The edge node PE1 generates paths P11 and P12 to the edge node PE2 and transfers the data along the paths.

A reference sign 802 indicates a virtual routing table held by the edge node PE1. In the virtual routing table, virtual routing and forwarding (VRF) is registered for each VPN user.

For example, in VRF 1 used by a first user, the path P11, which starts from the edge node PE1 as a transmission source, sequentially passes through the routers R1, R2, and R3, and reaches the edge node PE2, is registered. In VRF 2 used by a second user, the path P12, which starts from the edge node PE1 as the transmission source, sequentially passes through the routers R4, R5, and R6, and reaches the edge node PE2, is registered. As a result, traffic from the edge node PE1 to the edge node PE2 is appropriately distributed by the two paths P11 and P12 being used in a load-balanced manner.

Note that, since the two paths P11 and P12 in FIG. 8 do not pass through the same routers, it can be said that the paths P11 and P12 are routes that are low in coupling degree between the routes and high in reliability (fault resistance). For example, in a case where the router R2 fails, the traffic can bypass the router R2 by passing through the path P12 even if the path P11 is disconnected.

However, in a case where a plurality of routes are constructed by use of the path generation method described in the related art, a route with low reliability may be constructed.

FIG. 9 is an explanatory diagram illustrating an example of transfer with a route with low reliability.

In a network topology diagram indicated by a reference sign 811, the path P11 in FIG. 8 and a new path P13 sequentially passing through the routers R4, R1, R2, and R3 are formed. The paths P11 and P13 are also registered in a virtual routing table of the edge node PE1, which is indicated by a reference sign 812.

Note that, since the path P12 in FIG. 8 sequentially passes through the routers R4, R5, and R6, the delay between the edge nodes PE1 and PE2 is 1+1+3+1=6 [ms]. On the other hand, since the path P13 in FIG. 9 sequentially passes through the routers R4, R1, R2, and R3, the delay between the edge nodes PE1 and PE2 is 1+1+1+1+1=5 [ms]. Therefore, in a case where a TE index for selecting a path with a minimum delay is designated, the path P13 is adopted instead of the path P12.

However, between the paths P11 and P13, three nodes (the routers R1, R2, and R3) among all the six nodes (the routers R1 to R6) in the relay section are shared, and the reliability is lowered. For example, in a case where the router R2 fails, both the paths P11 and P13 are disconnected, and the traffic cannot bypass the router R2.

As described above, in a case where load balancing is performed by a plurality of paths, using a single TE index may lead to construction of a route whose reliability is not considered.

Therefore, a main object of the present invention is to construct a highly reliable route while a desired index is satisfied.

### Solution to Problem

In order to solve the above problem, a route calculation device of the present invention has the following features.

The present invention includes: an input unit that receives input parameters including an index for selecting a path to be set in a communication system;

a route calculation unit that selects a reference path based on the index and preferentially selects, from among one or more other paths each of which passes through a route different from the reference path, another path whose route has a lower degree of sharing a node through which the reference path passes; and

a route setting unit that sets the reference path and the another path selected by the route calculation unit in the communication system.

### Advantageous Effects of Invention

According to the present invention, it is possible to construct a highly reliable route while a desired index is satisfied.

### BRIEF DESCRIPTION OF DRAWINGS

FIG. 1 is a configuration diagram of a route calculation device and a communication system according to the present embodiment.

FIG. 2 is a hardware configuration diagram of the route calculation device according to the present embodiment.

FIG. 3 is a flowchart illustrating main processing of the route calculation device according to the present embodiment.

FIG. 4 is a flowchart illustrating details of path calculation processing in FIG. 3 according to the present embodiment.

FIG. 5 illustrates a table indicating a priority of each path focusing on a first TE index (delay) according to the present embodiment.

FIG. 6 illustrates a table indicating a priority of each path for each of the first TE index to a third TE index according to the present embodiment.

FIG. 7 is a result of calculating the sum of priorities from the priority table of FIG. 6 according to the present embodiment.

FIG. 8 is an explanatory diagram illustrating an example of transfer by SR.

FIG. 9 is an explanatory diagram illustrating an example of transfer with a route with low reliability.

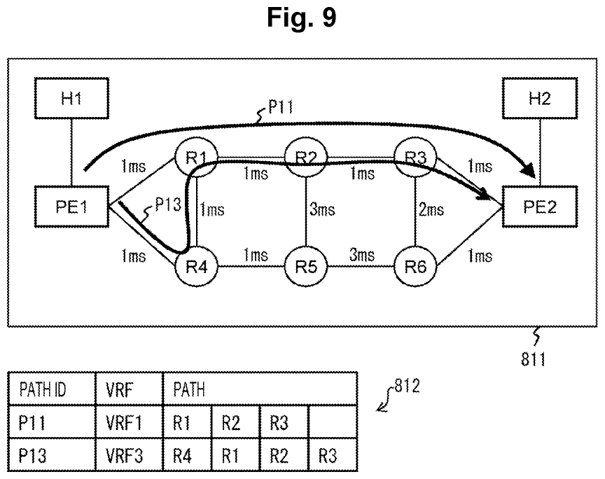

### DESCRIPTION OF EMBODIMENTS

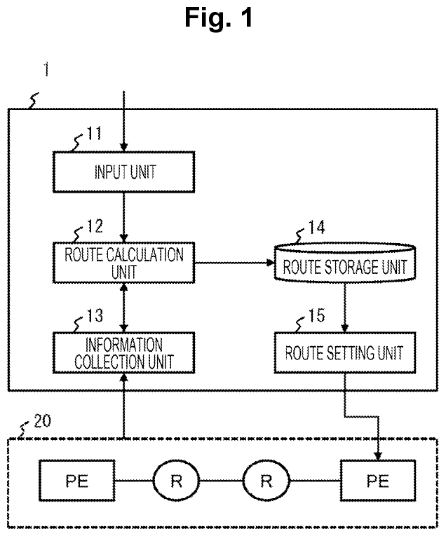

FIG. 1 is a configuration diagram of a route calculation device 1 and a communication system 20.

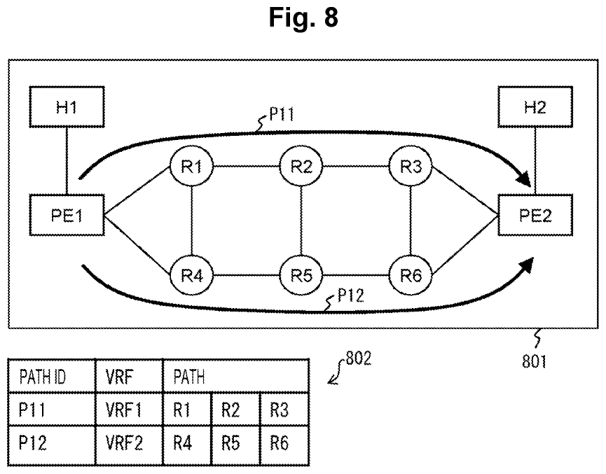

The communication system 20 includes edge nodes PE and routers R. Note that the communication system 20 in FIG. 1 is simply illustrated. However, the communication system 20 actually includes hosts H1 and H2 accommodated in the edge nodes PE as in the network topology diagram indicated by the reference sign 801 in FIG. 8. In addition, a route passing through the routers R between the edge nodes PE of the communication system 20 may be branched into a plurality of routes instead of one route.

The route calculation device 1 is a device that calculates a route of a path to be set in the communication system 20. Therefore, the route calculation device 1 includes an input unit 11, a route calculation unit 12, an information collection unit 13, a route storage unit 14, and a route setting unit 15.

The information collection unit 13 collects information such as topology necessary for path calculation in cooperation with a tool in the communication system 20. The tool is, for example, an application called a segment routing-path computation engine (SR-PCE) provided by Cisco. The SR-PCE collects line bandwidth, topology information, and the like by using the Simple Network Management Protocol (SNMP) or the Border Gateway Protocol-Link State (BGP-LS).

The input unit 11 receives input parameters for path calculation from an operator.

The route calculation unit 12 calculates a path to be set in the communication system 20 based on the input parameters of the input unit 11 and NW information of the information collection unit 13, and stores the path in the route storage unit 14.

The route setting unit 15 sets the path stored in the route storage unit 14 in an edge node PE serving as a starting point of the path in the communication system 20.

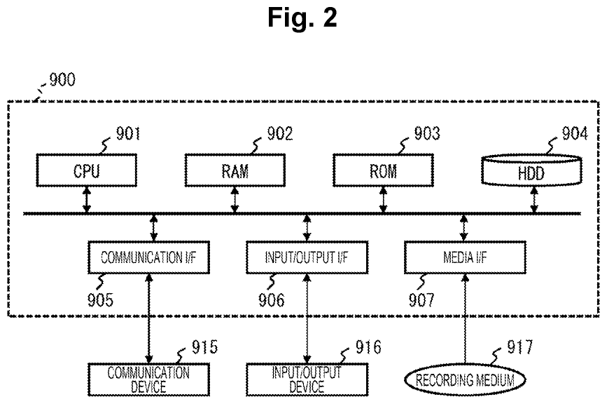

FIG. 2 is a hardware configuration diagram of the route calculation device 1.

The route calculation device 1 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Moreover, the CPU 901 controls each processing unit by executing a program (also referred to as an application or an app for abbreviation thereof) read into the RAM 902. This program can be distributed via a communication line, or can be distributed by being recorded on the recording medium 917 such as a CD-ROM.

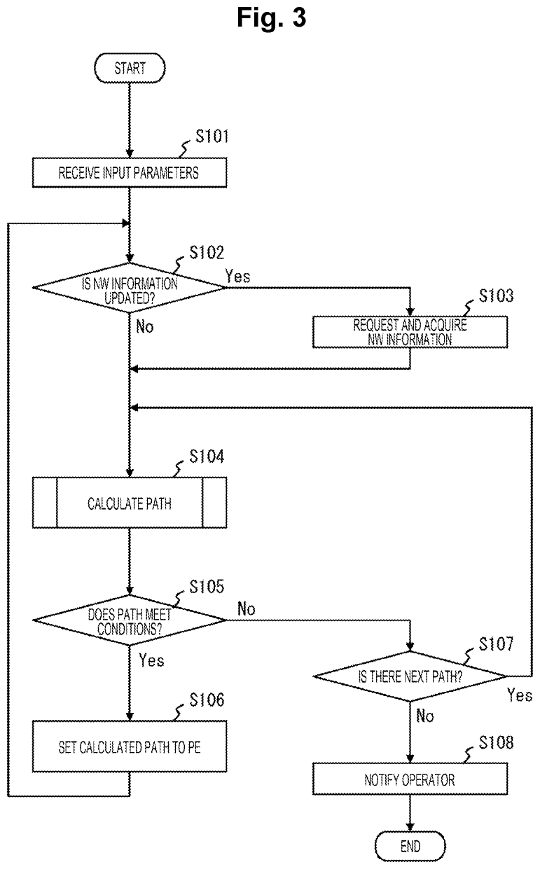

FIG. 3 is a flowchart illustrating main processing of the route calculation device 1.

The input unit 11 receives input parameters for path calculation from the operator (S101). The input parameters include information indicating a demand such as a service level agreement (SLA) to be satisfied by a calculated path. The input parameters are, for example, the following information.
One or more TE indices. For example, first TE index=delay, second TE index=jitter, and third TE index=band usage rate. A path in the first place in the first TE index is set as a first reference path.
A target value indicating an allowable range to be satisfied in each TE index. For example, delay (10%), jitter (10%), and band usage rate (30%). Note that the delay (10%) means that, in a case where the delay of the reference path is 10 ms, a path with a delay of 11 ms or less (100%+10% or less) is within the allowable range.
A weight in each TE index. For example, in a case where a weight a=1.2 is designated, the weight of the first TE index (a to the zeroth power=1), the weight of the second TE index (a to the first power=1.2), and the weight of the third TE index (a to the second power=1.44) are sequentially set. That is, the weight of an N-th TE index is a to the (N-1)-th power.
The number of routes to be calculated. For example, three routes are calculated, so that traffic is load-balanced in three directions.

The route calculation unit 12 determines whether network (NW) information indicating the state of the communication system 20 is updated (S102). In a case of Yes in S102, the processing proceeds to S103, and in a case of No, the processing proceeds to S104. In S103, the information collection unit 13 requests the NW information from the tool in the communication system 20, and acquires the updated NW information as a response. The NW information is, for example, the following information.
Topology information
Metric information
Delay, jitter
Band usage rate

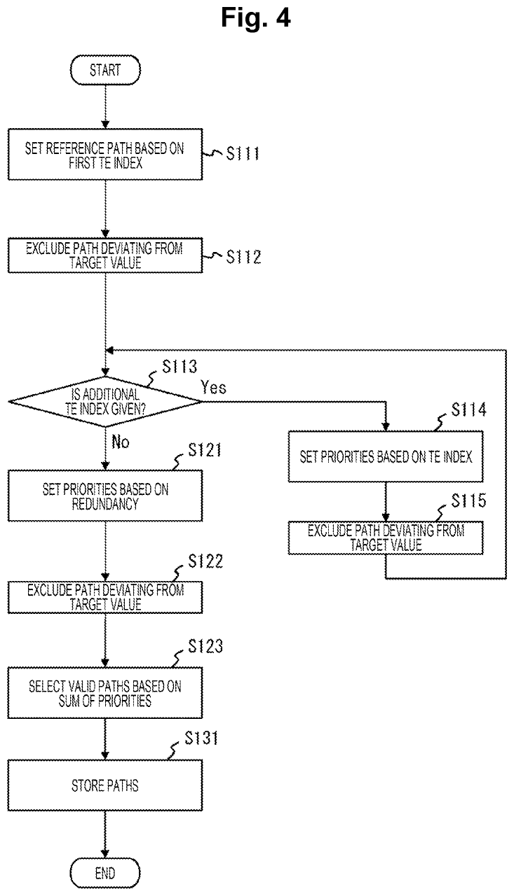

The route calculation unit 12 calculates a path to be set in the communication system 20 based on the input parameters in S101 and the NW information in S103, and stores the path in the route storage unit 14 (S104, details in FIG. 4).

The route calculation unit 12 reads the path calculated in S104 from the route storage unit 14, and determines whether the path meets conditions (target values of one or more TE indices) designated by the input parameters in S101 (S105). In a case of Yes in S105, the processing proceeds to S106, and in a case of No, the processing proceeds to S107.

In S106, the route setting unit 15 sets (installs) the calculated path to an edge node PE serving as a starting point of the path in the communication system 20, and returns the processing to S102.

On the other hand, in S107, since the path calculated in S104 this time cannot be adopted, it is necessary to calculate the next path. For example, it is assumed that the input parameters designate an SLA indicating that both the target value of the first TE index and the target value of the second TE index need to be satisfied. The current reference path has the highest priority in the first TE index, but does not satisfy the target value in the second TE index, and as a result, does not meet the designated conditions (S105, No). In this case, a new reference path having the second highest priority in the first TE index can be set as the next path, and S104 can be executed again.

When there is such a possible path that can be the next path (S107, Yes), the route calculation unit 12 returns to S104 and can try new uncalculated reference paths one after another.

However, when there is no possible path that can be the next path (S107, No), the route calculation unit 12 notifies the operator that a path that meets the current input parameters has not been found (S108).

FIG. 4 is a flowchart illustrating details of path calculation processing (S104) in FIG. 3.

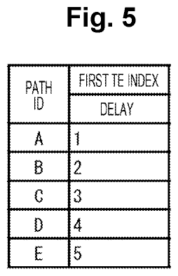

Hereinafter, the path calculation processing (S104) will be described along FIG. 4 with reference to each table of FIGS. 5 to 7.

The route calculation unit 12 generates a plurality of paths based on the first TE index (delay) given in S101. At this time, the route calculation unit 12 ranks the paths in order from the path that meets the first TE index most, and sets the path having the highest rank as a reference path (S111).

FIG. 5 illustrates a table indicating a priority of each path focusing on the first TE index (delay). Numerical values (1 to 5) in the priority table are relative ranks (first to fifth places) in a path set. Here, since paths A, B, C, D, and E are ranked in order from the first place with least delay, the path A in the first place is set as a reference path.

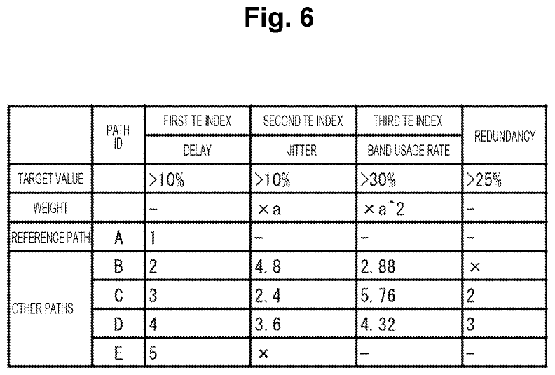

FIG. 6 illustrates a table indicating a priority of each path for each of the first TE index to the third TE index.

The ranks (1 to 5) of the paths A, B, C, D, and E in the first TE index are as described with reference to FIG. 5.

In the priority table of FIG. 6, columns indicating the second TE index (jitter), the third TE index (band usage rate), and the redundancy viewed from the reference path are added in addition to the first TE index.

In the priority table of FIG. 6, in addition to a row indicating priorities of the reference path A and rows indicating priorities of the other paths B to E, a row of a target value in each TE index (a value indicating an allowable difference from the reference path) and a row of a weight in each TE index are added.

In the row of a target value, the following information is defined as input parameters of S101.
The delay of the reference path A (for example, 10 ms) is set to 100%, and another path with a delay exceeding 100+10% (>10%) (for example, 130% for 13 ms) is set to be outside the target value.
The jitter of the reference path A is set to 100%, and another path with a jitter exceeding 100+10% (>10%) is set to be outside the target value.
The band usage rate of the reference path A is set to 100%, and another path with a band usage rate exceeding 100+30% (>30%) is set to be outside the target value.
Another path with a redundancy of 25% or more is set to be outside the target value. The redundancy indicates an overlapping rate of routers R through which the reference path A passes with routers R through which another path passes (sharing degree of SIDs through which the paths pass). For example, in a case where there are four routers R through which the reference path passes and one router R among routers R through which another path passes is also used for the reference path, the redundancy is ¼, that is, 25%. The lower the redundancy, the higher the independence from the reference path, and the path is highly reliable.

In the row of weight, the weight a=1.2 is reflected as an input parameter of S101.
The first TE index does not reflect the weight, and the numerical values of the ranks of the five paths are used as priorities as they are. Note that a smaller numerical value of priority indicates a path to be preferentially adopted.
For the second TE index, products obtained by multiplying the numerical values of the ranks of the five paths by the weight a=1.2 are set as priorities. For example, the path B in the second place in the second TE index has a priority of 2 [rank]×(weight a=1.2)=2.4.
For the third TE index, products obtained by multiplying the numerical values of the ranks of the five paths by the weight a to the second power=1.44 are set as priorities. For example, the path D in the third place in the third TE index has a priority of 3 [rank]×(weight a\hat{ }2=1.44)=4.32.

The route calculation unit 12 excludes a path deviating from the target value of the first TE index (S112). In FIG. 6, since there is no other path with a delay exceeding 110% (>10%) from the delay of the reference path A (=10 ms), exclusion is not performed (“x” is not written in cells of priority in FIG. 6).

In a case where a plurality of (additional) TE indices are given in S101 (S113, Yes), the route calculation unit 12 sets the next TE index (=jitter) as the second TE index and sets priorities of the other paths based on the ranks in the second TE index (S114). Note that priorities in the second and subsequent TE indices are values obtained by weighting the ranks. The route calculation unit 12 then sets the second TE index of the reference path A to 100%, and excludes a path deviating from the target value (S115).

Note that, in FIG. 6, the ranking in the jitter is as follows: the second place (path C), the third place (path D), the fourth place (path B), and the fifth place (path E). Since the jitter of the fifth place (path E) exceeds 110% (>10%) from the jitter of the reference path A, the path E is excluded (priority “x”).

The route calculation unit 12 performs similar processing for the third TE index (band usage rate) and subsequent indices (S113 to S115).

In FIG. 6, the ranking in the band usage rate is as follows: the first place (path B), the second place (path D), and the third place (path C). Since the band usage rate of each of the first to third places does not exceed 130% (>30%) from the band usage rate of the reference path A, exclusion is not performed (priority “x” is not written). Note that since the path E has already been excluded in the previous jitter, the path E is excluded even in the band usage rate (priority “-”).

In a case where the calculation of the priorities is completed for all the input TE indices (S113, No), the route calculation unit 12 performs prioritization based on the redundancy between the reference path and the other paths (S121).

The route calculation unit 12 excludes a path deviating from the set target value of the redundancy (S122). As a method of excluding a path deviating from the target value, a method of deleting the path, a method of significantly lowering the priority of the path, and the like can be considered.

In FIG. 6, the paths are ranked in ascending order of the redundancy as follows: the first place (path E), the second place (path C), the third place (path D), and the fourth place (path B). Since the first place (path E) has already been excluded in the jitter, the path E is excluded even in the redundancy. The fourth place (path B) is excluded in S122 because the redundancy with respect to the reference path A exceeds 25%.

The route calculation unit 12 calculates the sum of the calculated priorities for each path, and selects, as valid paths, the number of routes designated by an input parameter (for example, three routes) in ascending order of the sum of the priorities (S123). The route calculation unit 12 stores the valid paths in S123 in the route storage unit 14 (S131).

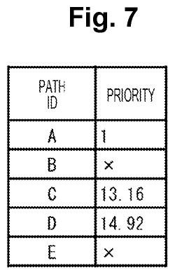

FIG. 7 illustrates a result of calculating the sum of the priorities from the priority table of FIG. 6.
In the reference path A, the total value is 1 [rank] of the first TE index as it is.
In the path C, the total value is 3+2.4+5.76+2=13.16.
In the path D, the total value is 4+3.6+4.32+3=14.92.

Therefore, a total of three paths of the reference path A, the path C, and the path D are selected as valid paths in ascending order of the total value (S123). Note that, since a path with a bad rank in the third TE index is multiplied by a larger weight than a path with a bad rank in the second TE index, the total value of the path with a bad rank in the third TE index increases more, and thus is less likely to be selected.

As a result, even in a case where the ranks in the TE indices are simply summed and the scores are the same, the scores are not the same when the weighted priorities are summed, and valid paths can be uniquely determined.

### Effects

A route calculation device 1 of the present invention includes: an input unit 11 that receives input parameters including an index for selecting a path to be set in a communication system 20;

a route calculation unit 12 that selects a reference path based on the index and preferentially selects, from among one or more other paths each of which passes through a route different from the reference path, a path having a lower degree of sharing a router R through which the reference path passes; and

a route setting unit 15 that sets the reference path and the another path selected by the route calculation unit 12 in the communication system 20.

This configuration makes it possible to generate a path with high reliability in consideration of the redundancy with respect to a plurality of routes while taking advantage of path generation using a TE index. Therefore, for example, even in a case where load balancing is performed by a plurality of paths in SR, traffic can be distributed by highly reliable routes.

In the route calculation device 1 of the present invention, the input unit 11 receives a plurality of the indices and an allowable range of each index as the input parameters, and the route calculation unit 12 excludes a path that does not satisfy the allowable range of each index among the other paths.

With this configuration, utilizing a plurality of TE indices for route selection makes it possible to cope with a complicated use case.

In the route calculation device 1 of the present invention, the route calculation unit 12 changes the reference path when the reference path does not satisfy the allowable range of each index.

With this configuration, a reference path that does not satisfy a desired level can be appropriately excluded by an index different from the index used when the reference path is selected.

In the route calculation device 1 of the present invention, the route calculation unit 12 calculates priorities of the other paths in each index based on ranks of the other paths in each index and weighting values different for each index, and determines an order of priority for selecting the another path based on the calculated priorities.

With this configuration, even when three or more indices are designated, the priorities of the other paths do not have the same score.

### Reference Signs List

1 Route calculation device
11 Input unit
12 Route calculation unit
13 Information collection unit
14 Route storage unit
15 Route setting unit
20 Communication system

1. A route calculation device comprising:
one or more processors, configured to:
receive input parameters including an index for selecting a path to be set in a communication system;
select a reference path based on the index and preferentially selects, from among one or more other paths each of which passes through a route different from the reference path, another path whose route has a lower degree of sharing a node through which the reference path passes; and
set the reference path and the another path selected in the communication system.

2. The route calculation device according to claim 1, wherein the one or more processors are configured to:
receive a plurality of the indices and an allowable range of each index as the input parameters, and
exclude a path that does not satisfy the allowable range of each index among the other paths.

3. The route calculation device according to claim 2, wherein the one or more processors are configured to:
change the reference path when the reference path does not satisfy the allowable range of each index.

4. The route calculation device according to claim 2, wherein the one or more processors are configured to:
calculate priorities of the other paths in each index based on ranks of the other paths in each index and weighting values different for each index, and determine an order of priority for selecting the another path based on the calculated priorities.

5. A route calculation method executed by a route calculation device comprising one or more processors, the route calculation method comprising:
receiving input parameters including an index for selecting a path to be set in a communication system;
selecting a reference path based on the index and preferentially selecting, from among one or more other paths each of which passes through a route different from the reference path, another path whose route has a lower degree of sharing a node through which the reference path passes; and
setting the reference path and the another path selected in the communication system.

6. A program non-transitory computer readable medium storing one or more instructions for causing a computer to function as a route calculation device to execute:
receiving input parameters including an index for selecting a path to be set in a communication system;
selecting a reference path based on the index and preferentially selecting, from among one or more other paths each of which passes through a route different from the reference path, another path whose route has a lower degree of sharing a node through which the reference path passes; and
setting the reference path and the another path selected in the communication system.

7. The route calculation method according to claim 5, comprising:
receiving a plurality of the indices and an allowable range of each index as the input parameters, and
excluding a path that does not satisfy the allowable range of each index among the other paths.

8. The route calculation method according to claim 7, comprising:
changing the reference path when the reference path does not satisfy the allowable range of each index.

9. The route calculation method according to claim 7, comprising:
calculating priorities of the other paths in each index based on ranks of the other paths in each index and weighting values different for each index, and determining an order of priority for selecting the another path based on the calculated priorities.

10. The non-transitory computer readable medium according to claim 6, wherein the one or more instructions cause the computer to execute:
receiving a plurality of the indices and an allowable range of each index as the input parameters, and
excluding a path that does not satisfy the allowable range of each index among the other paths.

11. The non-transitory computer readable medium according to claim 10, wherein the one or more instructions cause the computer to execute:
changing the reference path when the reference path does not satisfy the allowable range of each index.

12. non-transitory computer readable medium according to claim 10, wherein the one or more instructions cause the computer to execute:
calculating priorities of the other paths in each index based on ranks of the other paths in each index and weighting values different for each index, and determining an order of priority for selecting the another path based on the calculated priorities.
